(19) United States
(12) Patent Application Publication
(10) Pub. No.: US 2023/0388504 A1
(43) Pub. Date: Nov. 30, 2023

(54) VIDEO-DATA ENCODER

(71) Applicant: Microchip Technology Incorporated, Chandler, AZ (US)

(72) Inventors: Battu Prakash Reddy, Hyderabad (IN); Sathishkumar Donthu, Hyderabad (IN); Kranthi Kumar Ghanapuram, Jangaon (IN)

(21) Appl. No.: 18/056,139

(22) Filed: Nov. 16, 2022

(30) Foreign Application Priority Data
May 25, 2022 (IN) 202241030058

(51) Int. Cl. H04N 19/13; H04N 19/176; H04N 19/129; H04N 19/60; H04N 19/124

(52) U.S. Cl. CPC H04N 19/13; H04N 19/176; H04N 19/129; H04N 19/60; H04N 19/124

(57) ABSTRACT

Examples disclosed herein include a video-data encoder. The video data encoder may encode a 4×4 data block into a bit stream according to a context adaptive variable length coding. The 4×4 data block may be representative of video data. The video-data encoder may, while encoding the 4×4 data block, ignore at least some coefficients of the 4×4 data block. In some examples, the video-data encoder may ignore the at least some coefficients of the 4×4 data block by setting the at least some coefficients of the 4×4 data block to zero prior to encoding the 4×4 data block. Related devices, systems and methods are also disclosed.

### CROSS-REFERENCE TO RELATED APPLICATIONS

This application claims the benefit of the priority date of Indian Provisional Patent Application No. 202241030058, filed May 25, 2022, and titled “IMPROVEMENTS TO CONTEXT ADAPTIVE VARIABLE LENGTH CODING,” the disclosure of which is incorporated herein in its entirety by this reference.

### FIELD

Various examples relate generally to encoding video, image, and/or audio data in a digital format. More specifically, some examples relate to improvements related to context adaptive variable length coding (CAVLC). CAVLC may be used according to Recommendation H.264: Advanced Video Coding for Generic Audiovisual Services (H.264), which is also referred to in the art as Motion Picture Experts Group (MPEG)-4 Advanced Video Coding (AVC). H.264 is a video coding format for recording and/or distributing video, image, and/or audio. Unless otherwise stated herein, references to “H.264” should be understood to be inclusive of MPEG-4AVC. Additionally, devices, systems, and methods are disclosed.

### BACKGROUND

CAVLC may be used in video encoding, e.g., video encoding according to Recommendation H.264, without limitation. CAVLC may encode blocks of coefficients into a bit stream. CAVLC may take advantage of several characteristics of blocks of quantized coefficients.

### BRIEF DESCRIPTION THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a functional block diagram illustrating an apparatus according to one or more examples.

FIG. 2 is a functional block diagram illustrating an apparatus according to one or more examples.

FIG. 3 is a functional block diagram illustrating an apparatus according to one or more examples.

FIG. 4 is a flowchart of a method, according to one or more examples.

FIG. 5A and FIG. 5B are collectively a flowchart of a method, according to one or more examples.

FIG. 6A and FIG. 6B are collectively a flowchart of a method 600, according to one or more examples.

FIG. 7 is a block diagram of a device that, in one or more examples, may be used to implement various functions, operations, acts, processes, or methods disclosed herein.

### DETAILED DESCRIPTION

H.264 describes a video compression algorithm that may compress video data, e.g., video data formatted in a red, green, blue (RGB) format or in a luma or brightness, blue projection, and red projection (YUV) format, without limitation, into a compressed format. H.264 may operate on data blocks, e.g., one data block at a time. H.264 includes operations for prediction, transformation, and quantization. After the operations for prediction, transformation, and quantization, the data blocks are typically sparse, e.g., most of the data blocks may contain mostly zeros.

CAVLC is an entropy encoding scheme used in H.264 video compression following prediction, transformation, and quantization. CAVLC encodes 4×4 data blocks into bit streams by taking advantage of characteristics of quantized 4×4 data blocks (including, e.g., the sparse nature of the 4×4 data blocks, without limitation).

The contents of the 4×4 data blocks (e.g., values of the 4×4 data blocks) are often referred to as “coefficients.” Following prediction, transformation, and quantization, the coefficients may include non-zero coefficients, +1s, −1s, and zeros. Following prediction, transformation, and quantization, the 4×4 data blocks may be scanned according to a zig-zag scan pattern e.g., ordering the coefficients from a first coefficient to a last coefficient. The ordering of the coefficients may correspond to an ordering of the coefficients from low-frequency to high-frequency according to the transformation. As a non-limiting example, the transformation may be an integer transformation or a cosine transformation. The +1s and −1s corresponding to high frequencies (e.g., the latter coefficients) according to the transformation may be referred to as “trailing 1s,” “T1s,” or “trailing ones.”

CAVLC encoding of a 4×4 data block includes five stages as follows:
Stage 1—Encode total non-zero coefficients. Standard lookup tables are used to encode non-zero coefficients using a count of the non-zero coefficients and a count of the trailing ones of the 4×4 data block. The selection of the lookup table is determined by the count of non-zero coefficient in the neighboring blocks. Stage 1 of CAVLC typically takes 1 clock cycle.
Stage 2—Encode sign of trailing ones. A bit is assigned based on a sign of each of the trailing ones where 0 corresponds to +1 and 1 corresponds to −1. Stage 2 of CAVLC typically takes 1 clock cycle.
Stage 3—Encode the levels of the remaining non-zero coefficient. This stage takes one clock cycle per non-zero coefficient. Stage 3 of CAVLC can take up to 16 clock cycles. As a non-limiting example, in the case of a 4×4 data block including 16 non-zero coefficients, this stage of CAVLC typically takes 16 clock cycles.
Stage 4—Encode the total number of zeros before the last non-zero coefficient. Stage 4 of CAVLC typically takes 1 clock cycle.
Stage 5—Encode each run of zeros. Stage 5 of CAVLC typically takes one clock cycle per zero before the last non-zero coefficient. This stage can take up to 15 clock cycles. As a non-limiting example, in a case where a 4×4 block includes a non-zero coefficient in the last location (according to the zig-zag scan pattern), and 15 zeros before the last coefficient, this stage will take 15 clock cycles.

The run time of stage 3 and stage 5 may be complementary. For example, stage 3 takes one clock cycle for each non-zero coefficient and stage 5 takes one clock cycles for each zeros before the last non-zero coefficient. Thus, more non-zero coefficients means stage 3 will be longer and stage 5 will be shorter and more zero coefficients (before the last non-zero coefficient) will cause stage 5 to be longer and stage 3 to be shorter.

Some implementations of CAVLC involve running stage 3 and stage 5 in parallel so that the encoded output of stage 5 is available at the end of stage 4. Such implementations of CAVLC may take up to 19 clock cycles to process a 4×4 data block.

As an example of a processing time for all five stages, in a case of a 4×4 data block including 6 non-zero coefficients, the 6 non-zero coefficients including 2 trailing ones, the last non-zero coefficient at the tenth position, CAVLC may take one clock cycle for stage 1, one clock cycle for stage 2, four clock cycles for stage 3 (one for each of the non-zero coefficients excluding the trailing ones), one clock cycle for stage 4, and four clock cycles for stage 5 (one for each of the zeros before the last non-zero coefficient at the tenth position) (stage 5 may run in parallel with stage 3 without adding clock cycles because stage 3 and 5 may run in parallel)—a total of seven clock cycles.

As an example of a processing time for all five stages, in a case of a 4×4 data block including 16 non-zero coefficients, none of which are trailing ones, (the case in which stage 3 will take the longest) CAVLC may take one clock cycle for stage 1, one clock cycle for stage 2, 16 clock cycles for stage 3, one clock cycle for stage 4, and zero clock cycles for stage 5 (stage 5 may be skipped because there are no zero coefficients)—a total of 19 clock cycles.

As another example of a processing time for all five stages, in a case of a 4×4 data block including 15 zeros and a single non-zero coefficients in the last position (the non-zero coefficient not being a trailing one, i.e., the case in which stage 5 will take the longest) CAVLC may take one clock cycle for stage 1, one clock cycle for stage 2, one clock cycle for stage 3 (stage 3 may run in parallel with stage 5 without adding clock cycles because stage 3 and 5 may run in parallel), one clock cycle for stage 4, and 15 clock cycles for stage 5—a total of 18 clock cycles.

CAVLC may receive one coefficient per clock cycle, e.g., one coefficient may be stored into a buffer each clock cycle, without limitation. If CAVLC take 19 clock cycles, as a non-limiting example, to encode a 4×4 data block of 16 coefficients into a bit stream, CAVLC takes longer to process the 4×4 data block than it takes to receive the blocks. This may cause a delay in the video-encoding process. As a non-limiting example, the input may need to wait 3 clock cycles every 16 clock cycles to let CAVLC complete all 5 encoding stages. Such waiting introduces an 18.75% overhead wait time for every block and hence for the overall video frame.

This will impact the bandwidth and frame rate of the overall H.264 encoder. An alternative solution, to avoid the wait time, is to run CAVLC at higher clock frequency, e.g., 1.1875 times the clock frequency of quantization module. However, this will increase the power consumption of CAVLC and will involve clock domain crossing (CDC), which may require CDC first-in-first-out circuits (FIFOs).

Some examples set coefficients of a 4×4 data block to be zero to reduce the number of clock cycles required by CAVLC in the longest cases. Some examples may set at least some coefficients of a 4×4 data block to zero prior to, at an outset of, or during operations of CAVLC. Some examples may set two coefficients to zero. Some examples may set the last two coefficients (according to a zig-zag scan pattern) to zero. Alternatively, some examples may ignore one or more coefficient during one or more operations of CAVLC.

In H.264, after prediction, transformation, and quantization, 4×4 data blocks are typically sparse. In particular, most of the coefficients of most 4×4 data blocks are zeros. Further, based on the transformation, e.g., the integer transformation, without limitation, most 4×4 data blocks have zeros as the last two coefficients (e.g., the high-frequency coefficients). Thus, setting the last two coefficients of most 4×4 data blocks to zero may not affect values of coefficients of most 4×4 data blocks. Further, because the last two coefficients represent high-frequency data (e.g., according to the integer transformation) setting the last two coefficients to zero may not cause a visually-noticeable impact to the video quality.

Setting two coefficients of 4×4 data blocks to zero will cause stage 3 of CAVLC to take a maximum of 14 clock cycles. For example, the 4×4 data block that would take stage 3 of CAVLC the longest to process would be a 4×4 data block including 16 non-zero coefficients, none of which are trailing ones. Using typical CAVLC, 16 non-zero coefficients would take 16 clock cycles to encode at CAVLC stage 3. By setting the last two coefficients to zero, according to various examples, stage 3 will take a maximum of 14 clock cycles because there will be a maximum of 14 non-zero coefficients to encode at stage 3.

In some non-limiting examples, in which a 4×4 data block includes 16 non-zero coefficients, none of which are trailing ones, various examples may compute stage 1 and stage 2 in the same clock cycle. Various examples may compute stage 3 in 14 clock cycles, because, after setting two coefficients of 4×4 data blocks to zero, there are 14 non-zero coefficients in the 4×4 data block. Stage 4 may be computed in one clock cycle. Stage 5 may be omitted because, in the case of 14 non-zero coefficients (e.g., after setting the last two coefficients to zero according to various examples), there are no runs of zeroes to be encoded at stage 5, alternatively, stage 5 may be processed in parallel with stage 3 and may not add any clock cycles to the total run time of CAVLC. Thus, even in the case of a 4×4 data block including 16 non-zero coefficients, none of which are trailing ones, various examples may take 16 clock cycles to process the 4×4 data block according to CAVLC.

In cases in which a 4×4 data block includes 15 zeros and a last non-zero coefficient (which may be the 4×4 data block that takes the longest for stage 5 to process), various examples may set the last coefficient to zero. With 16 zeros, stage 1 and stage 2 may take one clock cycle, stage 3 may take no clock cycles (because there are no non-zero coefficients to encode), alternatively, stage 3 may be processed in parallel with stage 5 and may not add any clock cycles to the total run time of CAVLC, stage 4 may take one clock cycle, and stage 5 may take no clock cycles (because there are no zeros before a last non-zero coefficient).

In cases in which a 4×4 data block includes 13 zeros and a non-zero coefficient in the 14th position (which may be the 4×4 data block that takes the longest for stage 5 to process after setting the last two coefficients to zero), various examples may set the last two coefficients to zero. With 13 zeros, stage 1 and stage 2 may take one clock cycle, stage 3 may take one clock cycles (for the non-zero coefficient in the 14th position), stage 4 may take one clock cycle, and stage 5 may take 13 clock cycles (for the 13 zeros preceding the 14th non-zero coefficient). Because stage 3 and stage 5 may be processed in parallel, the stages 1 through 5 of CAVLC may be completed in 15 clock cycles.

Thus, setting the last two coefficients of 4×4 data blocks to zero may allow CAVLC to be able to process all 4×4 data blocks in 16, or fewer, clock cycles.

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are only examples and should not be construed as the only way to implement the present disclosure unless specified otherwise herein. Additionally, block definitions and partitioning of logic between various blocks is an example of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code, without limitation) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

In this description the term “coupled” and derivatives thereof may be used to indicate that two elements co-operate or interact with each other. When an element is described as being “coupled” to or with another element, then the elements may be in direct physical or electrical contact or there may be one or more intervening elements or layers present. In contrast, when an element is described as being “directly coupled” to or with another element, then there are no intervening elements or layers present. It will be understood that when an element is referred to as “coupling” a first element and a second element then it is coupled to the first element and it is coupled to the second element.

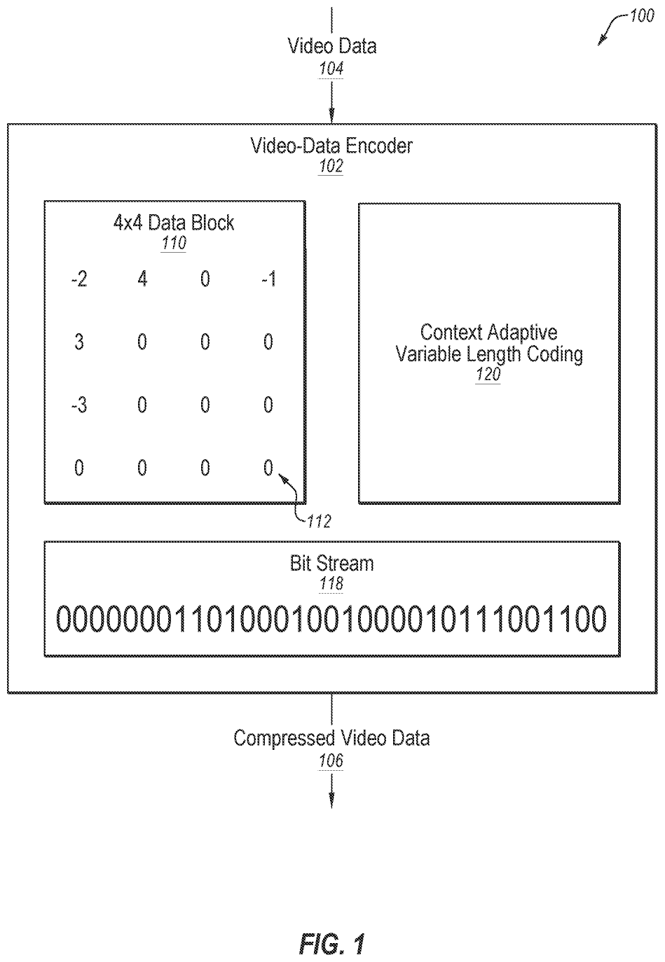

FIG. 1 is a functional block diagram illustrating an apparatus 100 according to one or more examples. Apparatus 100 may compress video data 104 into compressed video data 106 in 16, or fewer, clock cycles.

Apparatus 100 may include a video-data encoder 102. Video-data encoder 102 may encode video data 104 to generate compressed video data 106. Encoding video data 104 to generate compressed video data 106 may include encoding 4×4 data block 110 into a bit stream 118 according to a CAVLC 120. 4×4 block of data 110 may be representative of video data 104. Encoding video data 104 to generate compressed video data 106 may include, while encoding 4×4 data block 110, ignoring at least some coefficients 112 of 4×4 data block 110. In some non-limiting examples, ignoring at least some coefficients 112 of 4×4 data block 110 may include, prior to encoding 4×4 data block 110, setting at least some of coefficients 112 of 4×4 data block 110 to zero.

Video-data encoder 102 may be, or may include, logic to perform operations to compress video data 104 into compressed video data 106. Video-data encoder 102 may be, or may include a video codec.

Video data 104 may be, or may include, video data, image data, and/or audio data according to any suitable format, including e.g., video data made up of images including RGB data or YUV data, without limitation.

Compressed video data 106 may be representative of video data 104. Compressed video data 106 may be capable of being expanded to recover data that is substantially the same as video data 104. Some of the recovered data may not include high-frequency aspects that were present in video data 104. Nevertheless, the recovered data may be substantially the same as video data 104.

4×4 data block 110 may be, or may include, 16 coefficients 112. Coefficients 112 of 4×4 data block 110 may have respective positions in a 4×4 matrix. Additionally or alternatively, coefficients 112 of 4×4 data block 110 may have an order according to a zig-zag scan pattern (not illustrated in FIG. 1) of 4×4 data block 110.

4×4 data block 110 may be representative of video data 104. As a non-limiting example, 4×4 data block 110 may be representative of pixels of an image of video data 104. As a non-limiting example, a block of 16 pixels of an image of video data 104 may be identified or selected. A prediction may be performed relative to the pixels. Values related to the identified 16 pixels may be transformed, e.g., using an integer transformation, without limitation. The transformed values may be quantized. 4×4 data block 110 may be the quantized values.

Video-data encoder 102 may encode 4×4 data block 110 as bit stream 118 according to CAVLC 120. As a non-limiting example, video-data encoder 102 may encode 4×4 data block 110 as bit stream 118 according to the 5 stages of CAVLC described above.

However, according to some non-limiting examples, video-data encoder 102 may ignore at least some of coefficients 112 of 4×4 data block 110 while encoding 4×4 data block 110 into bit stream 118. For example, video-data encoders 102 may ignore at least two of coefficients 112 of 4×4 data block 110 while performing operations of CAVLC 120. In one or more examples, video-data encoders 102 may ignore the last two of coefficients 112 of 4×4 data block 110, according to a zig-zag scan pattern.

Additionally or alternatively, according to some non-limiting examples, video-data encoder 102 may set at least some of coefficients 112 of 4×4 data block 110 to zero prior to or at the outset of encoding 4×4 data block 110 into bit stream 118. For example, video-data encoder 102 may set at least two of coefficients 112 of 4×4 data block 110 to zero prior to performing operations of CAVLC 120. Video-data encoder 102 may set the last two of coefficients 112 of 4×4 data block 110, according to a zig-zag scan pattern (i.e., the last two coefficients traversed according to the zig-zag scan pattern), to a zero (i.e., set the value to zero). Setting at least some of coefficients 112 to zero may be an example of ignoring the at least some of coefficients 112.

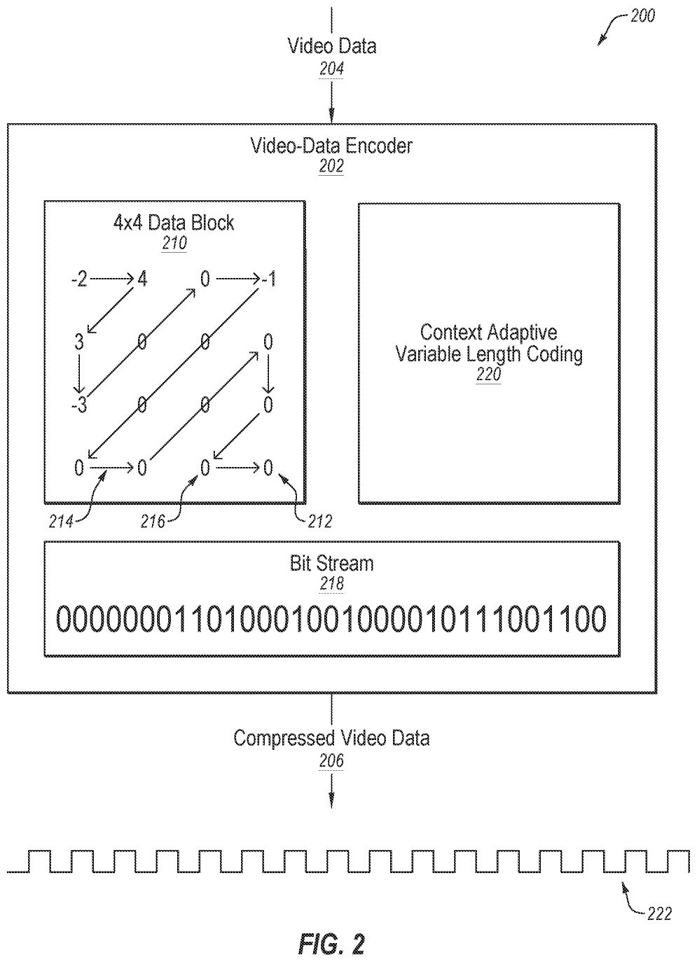

FIG. 2 is a functional block diagram illustrating an apparatus 200 according to one or more examples. Apparatus 200 may compress video data 204 into compressed video data 206 in 16, or fewer, clock cycles 222.

Apparatus 200 may be an example of apparatus 100 of FIG. 1. Specifically, video-data encoder 202 may be an example of video-data encoder 102 of FIG. 1, video data 204 may be an example of video data 104 of FIG. 1, compressed video data 206 may be an example of compressed video data 106 of FIG. 1, 4×4 data block 210 may be an example of 4×4 data block 110 of FIG. 1, coefficients 212 may be an example of coefficients 112 of FIG. 1, bit stream 218 may be an example of bit stream 118 of FIG. 1, and CAVLC 220 may be an example of CAVLC 120 of FIG. 1.

Additionally, FIG. 2 illustrates zig-zag scan pattern 214. Zig-zag scan pattern 214 may define a path to traverse 4×4 data block 210 to order coefficients 212 of 4×4 data block 210. Zig-zag scan pattern 214 may order coefficients 212 from a lowest-frequency coefficient to a highest lowest-frequency coefficient according to the transformation of the values of the block of pixels that formed 4×4 data block 210. In particular, a top-left coefficient of 4×4 data block 210 may be a lowest-frequency coefficient of coefficients 212 and a bottom-right coefficient of 4×4 data block 210 may be a highest-frequency coefficient of coefficients 212.

Video-data encoder 202 may ignore at least some of coefficients 212 of 4×4 data block 210 while encoding 4×4 data block 210 into bit stream 218 according to CAVLC 220. Video-data encoder 202 may ignore at least two of coefficients 212 of 4×4 data block 210 while performing operations of CAVLC 220. Video-data encoder 202 may ignore last two coefficients 216 of 4×4 data block 210, according to zig-zag scan pattern 214.

Additionally or alternatively, video-data encoder 202 may set at least some of coefficients 212 of 4×4 data block 210 to zero prior to or at the outset of encoding 4×4 data block 210 into bit stream 218 according to CAVLC 220. Video-data encoder 202 may set at least two of coefficients 212 of 4×4 data block 210 to zero. Video-data encoder 202 may set last two coefficients 216 of 4×4 data block 210, according to a zig-zag scan pattern 214, to zero. Setting at least some of coefficients 212 to zero may be an example of ignoring the at least some of coefficients 212.

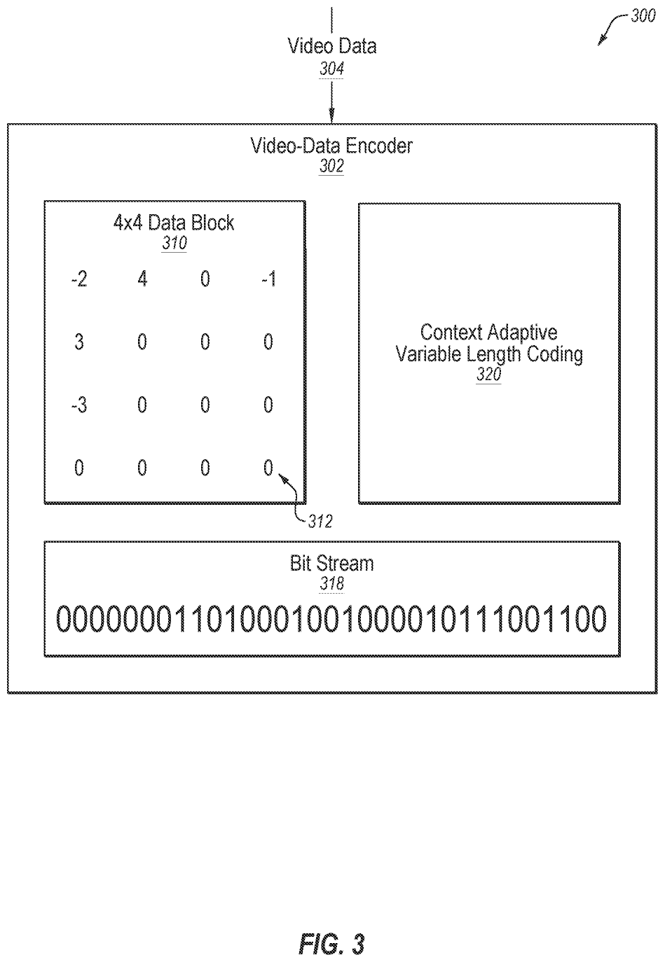

FIG. 3 is a functional block diagram illustrating an apparatus 300 according to one or more examples. Apparatus 300 may compress video data into compressed video data in 16, or fewer, clock cycles.

Apparatus 300 may be an example of apparatus 100 of FIG. 1. Specifically, video-data encoder 302 may be an example of video-data encoder 102 of FIG. 1, video data 304 may be an example of video data 104 of FIG. 1, 4×4 data block 310 may be an example of 4×4 data block 110 of FIG. 1, coefficients 312 may be an example of coefficients 112 of FIG. 1, bit stream 318 may be an example of bit stream 118 of FIG. 1, and CAVLC 320 may be an example of CAVLC 120 of FIG. 1.

Apparatus 300 may include video-data encoder 302. Video-data encoder 302 may encode 4×4 data block 310 into bit stream 318 according to CAVLC 320. 4×4 data block 310 may be representative of video data 304 (e.g., 4×4 data block 310 may be include data of video data 304 that has been selected, predicted, transformed, and/or quantized). Video-data encoder 302 may, while encoding 4×4 data block 310 ignore at least some coefficients 312 of 4×4 data block 310. In some non-limiting examples, ignoring at least some coefficients 312 of 4×4 data block 310 may include, prior to encoding 4×4 data block 310, setting at least some of coefficients 312 of 4×4 data block 310 to zero.

Video-data encoder 302 may ignore at least some of coefficients 312 of 4×4 data block 310 while encoding 4×4 data block 310 into bit stream 318 according to CAVLC 320. Video-data encoder 302 may ignore at least two of coefficients 312 of 4×4 data block 310 while performing operations of CAVLC 320. Video-data encoder 302 may ignore the last two coefficients of 4×4 data block 310, according to a zig-zag scan pattern.

Additionally or alternatively, video-data encoder 302 may set at least some of coefficients 312 of 4×4 data block 310 to zero prior to or at the outset of encoding 4×4 data block 310 into bit stream 318 according to CAVLC 320. Video-data encoder 302 may set at least two of coefficients 312 of 4×4 data block 310 to zero. Video-data encoder 302 may set the last two coefficients of 4×4 data block 310, according to a zig-zag scan pattern, to zero. Setting at least some of coefficients 312 of 4×4 data block 310 to zero may be an example of ignoring the at least some of coefficients 312 of 4×4 data block 310.

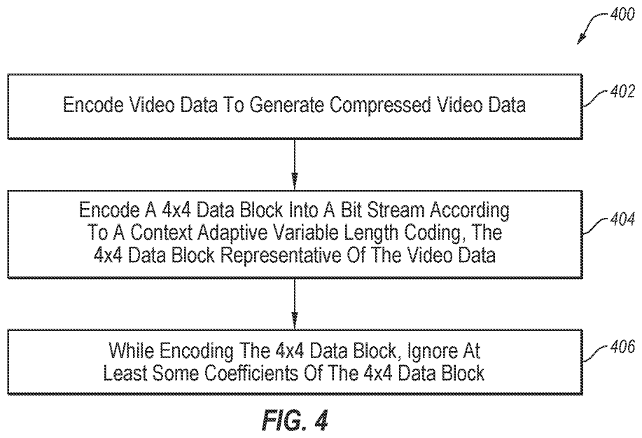

FIG. 4 is a flowchart of a method 400, according to one or more examples. At least a portion of method 400 may be performed, in some non-limiting examples, by a device or system, such as apparatus 100 of FIG. 1, device video-data encoder 102 of FIG. 1, apparatus 200 of FIG. 2, video-data encoder 202 of FIG. 2, apparatus 300 of FIG. 3, video-data encoder 302 of FIG. 3, or another device or system. Although illustrated as discrete blocks, various blocks may be divided into additional blocks, combined into fewer blocks, or eliminated, depending on the desired implementation.

At operation 402, video data may be encoded to generate compressed video data. As a non-limiting example, video data 104 of FIG. 1 may be compressed into compressed video data 106 of FIG. 1. One or more of operation 404 and operation 406 may performed in the performance of operation 402. In other words, one or more of operation 404 and operation 406 may be sub-steps of operation 402.

At operation 404, the 4×4 data block may be encoded into a bit stream according to a CAVLC. The 4×4 data block may be representative of the video data. As a non-limiting example, data from the video data may have been identified, predicted, transformed, and/or quantized to generate the 4×4 data block. The bit stream may represent compressed video data. As a non-limiting example of operation 404, 4×4 data block 110 may be encoded into bit stream 118 of FIG. 1 according to CAVLC 120 of FIG. 1.

At operation 406, at least some coefficients of a 4×4 data block may ignored while encoding the 4×4 data block. As a non-limiting example of operation 404, at least some of coefficients 112 of FIG. 1 of 4×4 data block 110 may be ignored while encoding data block 110 into bit stream 118. In some non-limiting examples, at least two of the coefficients of the 4×4 data block may be ignored. In some non-limiting examples, the last two coefficients of the 4×4 data block, according to a zig-zag scan pattern, may be ignored.

Setting coefficients to zero may be an example of ignoring the coefficients. For example, at least some coefficients (e.g., two, without limitation, e.g., the last two coefficients, without limitation) may be set to zero operation 406.

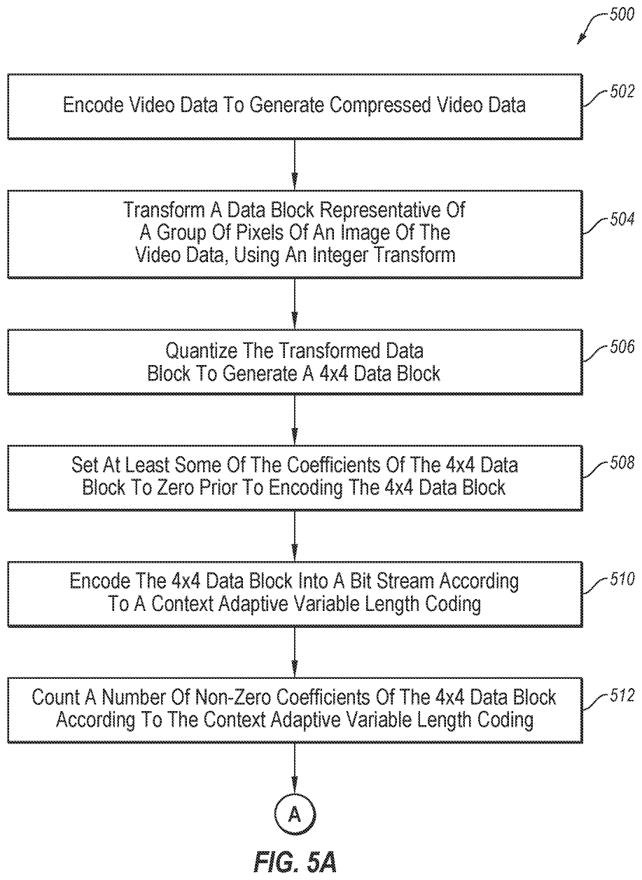

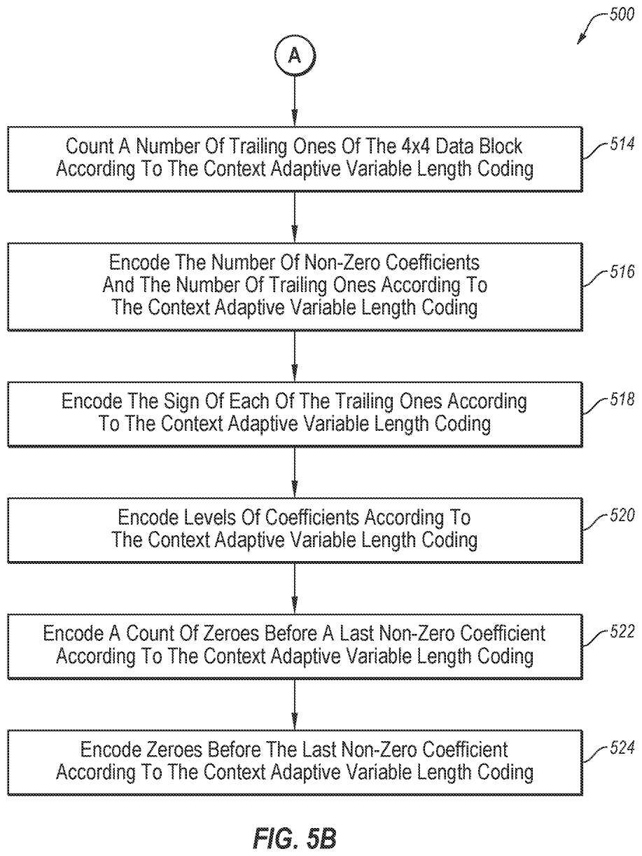

FIG. 5A and FIG. 5B are collectively a flowchart of a method 500, according to one or more examples. At least a portion of method 500 may be performed, in some non-limiting examples, by a device or system, such as apparatus 100 of FIG. 1, device video-data encoder 102 of FIG. 1, apparatus 200 of FIG. 2, video-data encoder 202 of FIG. 2, apparatus 300 of FIG. 3, video-data encoder 302 of FIG. 3, or another device or system. Although illustrated as discrete blocks, various blocks may be divided into additional blocks, combined into fewer blocks, or eliminated, depending on the desired implementation.

At operation 502, video data may be encoded to generate compressed video data. As a non-limiting example, video data 104 of FIG. 1 may be compressed into compressed video data 106 of FIG. 1. One or more of operation 504, operation 506, operation 508, operation 510, operation 512, operation 514, operation 516, operation 518, operation 520, operation 522, and operation 524 may performed in the performance of operation 502. In other words, one or more of operation 504, operation 506, operation 508, operation 510, operation 512, operation 514, operation 516, operation 518, operation 520, operation 522, and operation 524 may be sub-steps of operation 502.

At operation 504, a data block representative of video data may be transformed using an integer transform. As a non-limiting example, the data block may be representative of a group of pixels of an image of video data. As a non-limiting example of operation 504, a data block representative of video data 104 may be transformed using an integer transform.

At operation 506, the transformed data block may be quantized to generate a 4×4 data block. As a non-limiting example, the data block transformed at operation 504, may be quantized to generate 4×4 data block 110 of FIG. 1.

At operation 508, at least some coefficients of the 4×4 data block may be set to zero. The 4×4 data block may be representative of the video data. Data from the video data may have been identified, predicted, transformed (e.g., at operation 504), and/or quantized (e.g., at operation 506) to generate the 4×4 data block. As a non-limiting example of operation 508, at least some of coefficients 112 of FIG. 1 of 4×4 data block 110 may be set to zero. In some non-limiting examples, at least two of the coefficients of the 4×4 data block may be set to zero. In some non-limiting examples, the last two coefficients of the of the 4×4 data block, according to a zig-zag scan pattern, may be set to zero.

At operation 510, the 4×4 data block may be encoded into a bit stream according to a CAVLC. The bit stream may represent compressed video data. As a non-limiting example of operation 510, 4×4 data block 110 may be encoded into bit stream 118 of FIG. 1 according to CAVLC 120 of FIG. 1. One or more of operation 512, operation 514, operation 516, operation 518, operation 520, operation 522 and operation 524 may performed in the performance of operation 510. In other words, one or more of operation 512, operation 514, operation 516, operation 518, operation 520, operation 522 and operation 524 may be sub-steps of operation 510.

At operation 512, a number of non-zero coefficients of the 4×4 data block may be counted according to the CAVLC.

At operation 514, a number of trailing ones of the 4×4 data block may be counted according to the CAVLC.

At operation 516, the number of non-zero coefficients and the number of trailing ones may be encoded according to the CAVLC. Operation 512, operation 514, and operation 516 may be performed according to stage 1 of the CAVLC.

At operation 518, the sign of each of the trailing ones may be encoded according to the CAVLC. Operation 518 may be performed according to stage 2 of the CAVLC.

In some non-limiting examples, operation 512, operation 514, operation 516, and operation 518 may be performed during the same clock cycle. In some non-limiting examples, stage 1 and stage 2 of the CAVLC may be performed during the same clock cycle.

At operation 520, levels of remaining non-zero coefficients may be encoded according to the CAVLC. Operation 520 may be performed according to stage 3 of the CAVLC.

At operation 522, a count of zeroes before a last non-zero coefficient may be encoded according to the CAVLC. Operation 522 may be performed according to stage 4 of the CAVLC.

At operation 524, zeroes before the last non-zero coefficient may be encoded according to the CAVLC. Operation 524 may be performed according to stage 5 of the CAVLC.

In some non-limiting examples, operation 520 may be performed in parallel with operation 524. In some non-limiting examples, stage 3 and stage 5 of the CAVLC may be performed in parallel.

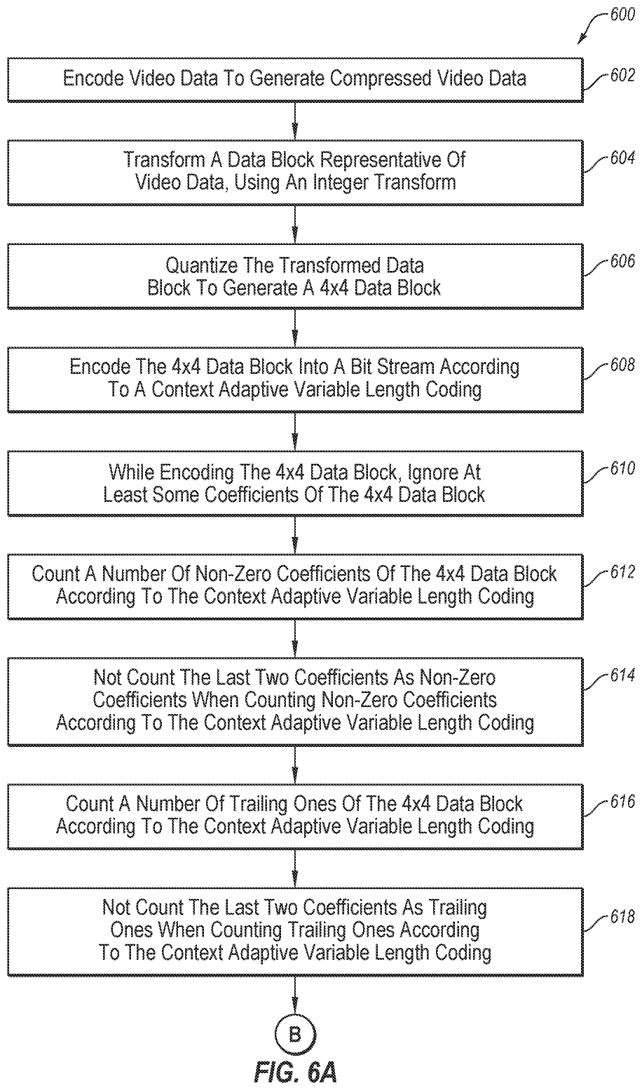

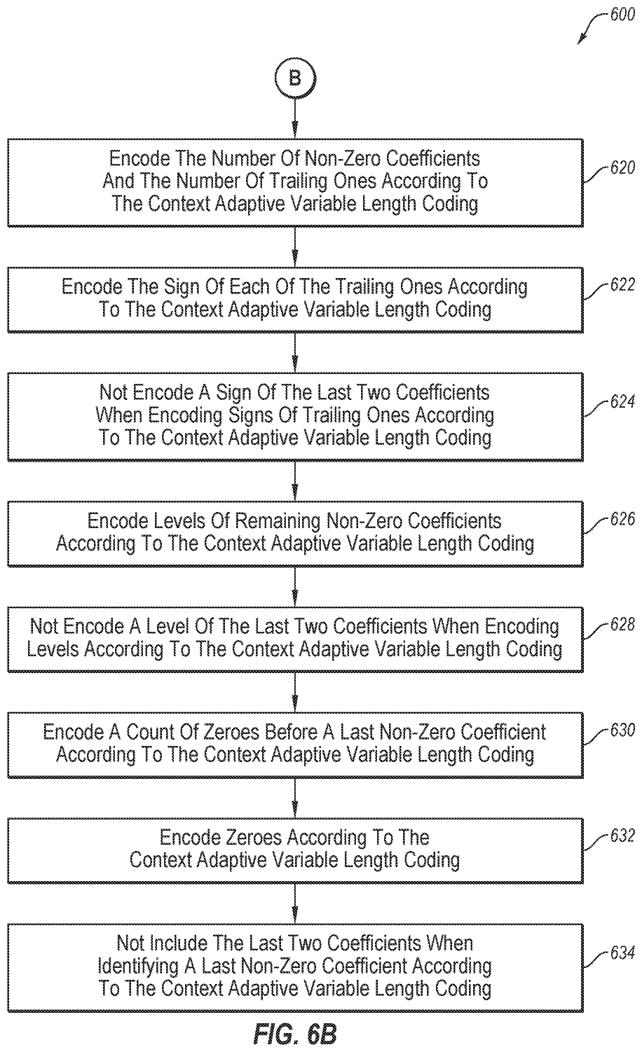

FIG. 6A and FIG. 6B are collectively a flowchart of a method 600, according to one or more examples. At least a portion of method 600 may be performed, in some non-limiting examples, by a device or system, such as apparatus 100 of FIG. 1, device video-data encoder 102 of FIG. 1, apparatus 200 of FIG. 2, video-data encoder 202 of FIG. 2, apparatus 300 of FIG. 3, video-data encoder 302 of FIG. 3, or another device or system. Although illustrated as discrete blocks, various blocks may be divided into additional blocks, combined into fewer blocks, or eliminated, depending on the desired implementation.

At operation 602, video data may be encoded to generate compressed video data. As a non-limiting example, video data 104 of FIG. 1 may be compressed into compressed video data 106 of FIG. 1. One or more of operation 604, operation 606, operation 608, operation 610, operation 612, operation 614, operation 616, operation 618, operation 620, operation 622, operation 624, operation 626, operation 628, operation 630, operation 632, and operation 634 may performed in the performance of 602. In other words, one or more of operation 604, operation 606, operation 608, operation 610, operation 612, operation 614, operation 616, operation 618, operation 620, operation 622, operation 624, operation 626, operation 628, operation 630, operation 632, and operation 634 may be sub-steps of operation 602.

At operation 604, a data block representative of video data may be transformed using an integer transform. As a non-limiting example, the data block may be representative of a group of pixels of an image of video data. As a non-limiting example of operation 604, a data block representative of video data 104 may be transformed using an integer transform.

At operation 606, the transformed data block may be quantized to generate a 4×4 data block. As a non-limiting example, the data block transformed at operation 604, may be quantized to generate 4×4 data block 110 of FIG. 1.

At operation 608, the 4×4 data block may be encoded into a bit stream according to a CAVLC. The bit stream may represent compressed video data. As a non-limiting example of operation 608, 4×4 data block 110 may be encoded into bit stream 118 of FIG. 1 according to CAVLC 120 of FIG. 1. One or more of operation 610, operation 612, operation 614, operation 616, operation 618, operation 620, operation 622, operation 624, operation 626, operation 628, operation 630, operation 632, and operation 634 may performed in the performance of operation 610. In other words, one or more of operation 610, operation 612, operation 614, operation 616, operation 618, operation 620, operation 622, operation 624, operation 626, operation 628, operation 630, operation 632, and operation 634 may be sub-steps of operation 608.

At operation 610, while encoding the 4×4 data block (e.g., at operation 608), at least some of the coefficients of the 4×4 data block may be ignored. The 4×4 data block may be representative of the video data. As a non-limiting example, data from the video data may have been identified, predicted, transformed (e.g., at operation 604), and/or quantized (e.g., at operation 606) to generate the 4×4 data block. As a non-limiting example, at least some of coefficients 112 of FIG. 1 of 4×4 data block 110 may be ignored. In some non-limiting examples, at least two of the coefficients of the 4×4 data block may be ignored. In some non-limiting examples, the last two coefficients of the 4×4 data block, according to a zig-zag scan pattern, may be ignored. Any or all of operation 614, operation 618, operation 622, operation 628, and operation 630 may be examples of ignoring coefficients of operation 612 at various stages of the CAVLC.

At operation 612, a number of non-zero coefficients of the 4×4 data block may be counted according to the CAVLC.

At operation 614, when counting non-zero coefficients according to the CAVLC (e.g., at operation 612), the last two coefficients may not be counted as non-zero coefficients, regardless of whether the last two coefficients are non-zero coefficients or not. In other words, when counting non-zero coefficients according to the CAVLC (e.g., at operation 612), the last two coefficients may be ignored.

At 616, a number of trailing ones of the 4×4 data block may be counted according to the CAVLC.

At operation 618, when counting trailing ones according to the CAVLC (e.g., at operation 616), the last two coefficients may not be counted as trailing ones, regardless of whether the last two coefficients are ones or not. In other words, when counting trailing ones according to the CAVLC (e.g., at operation 616), the last two coefficients may be ignored.

At operation 620, the number of non-zero coefficients and the number of trailing ones may be encoded according to the CAVLC. Operation 612, operation 616, and operation 620 may be performed according to stage 1 of the CAVLC. Operation 614 and operation 618 may be modifications affecting stage 1 of the CAVLC.

At operation 622, the sign of each of the trailing ones may be encoded according to the CAVLC. Operation 622 may be performed according to stage 2 of the CAVLC.

At operation 624, when encoding signs of trailing ones according to the CAVLC (e.g., at operation 622), a sign of the last two coefficients may not be encoded. In other words, when encoding signs of trailing ones according to the CAVLC, the last two coefficients may be ignored. Operation 624 may be a modification affecting stage 2 of the CAVLC.

In some non-limiting examples, one or more of operation 612, operation 616, operation 620, and operation 622 may be performed during the same clock cycle. As a non-limiting example, stage 1 of the CAVLC and stage 2 of the CAVLC may be performed during the same clock cycle. Additionally, in some non-limiting examples, one or more of operation 614, operation 618, and operation 624 may be performed during the same clock cycle, i.e., the same clock cycle during which one or more of operation 612, operation 616, operation 620, and operation 622 were performed.

At operation 626, levels of remaining non-zero coefficients may be encoded according to the CAVLC. Operation 626 may be performed according to stage 3 of the CAVLC.

At operation 628, when encoding levels according to the CAVLC (e.g., at operation 626), a level of the last two coefficients may not be encoded. In other words, when encoding levels of remaining non-zero coefficients according to the CAVLC, the last two coefficients may be ignored. Operation 628 may be a modification affecting stage 3 of the CAVLC.

At operation 630, a count of zeroes before a last non-zero coefficient may be encoded according to the CAVLC. Operation 630 may be performed according to stage 4 of the CAVLC.

At operation 632, zeroes before the last non-zero coefficient may be encoded according to the CAVLC. Operation 632 may be performed according to stage 5 of the CAVLC.

In some non-limiting examples, one or both of operation 626 and operation 628 may be performed in parallel with operation 632. As a non-limiting example, stage 3 and stage 5 of the CAVLC may be performed in parallel.

At operation 634, when identifying the last non-zero coefficient according to the CAVLC (e.g., the last non-zero coefficient of one or both of operation 630 and operation 632), the last two coefficients may not be included for consideration. In other words, when identifying the last non-zero coefficient according to the CAVLC, the last two coefficients may be ignored. Operation 634 may be a modification affecting one or both of stage 4 and stage 5 of the CAVLC.

Modifications, additions, or omissions may be made to method 400, method 500, and/or method 600 without departing from the scope of the present disclosure. For example, the operations of method 400, method 500, and/or method 600 may be implemented in differing order. Furthermore, the outlined operations and actions are only provided as examples, and some of the operations and actions may be optional, combined into fewer operations and actions, or expanded into additional operations and actions without detracting from the essence of the disclosed example.

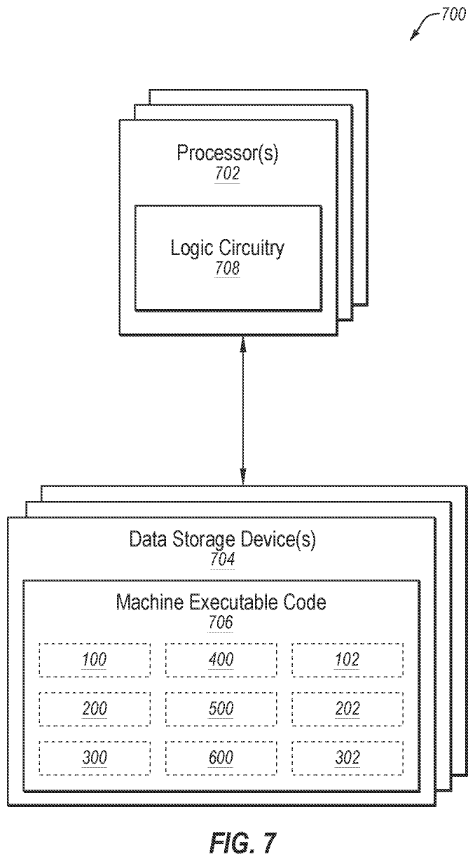

FIG. 7 is a block diagram of a device 700 that, in one or more examples, may be used to implement various functions, operations, acts, processes, or methods disclosed herein. Device 700 includes one or more processors 702 (sometimes referred to herein as “processors 702”) operably coupled to one or more apparatuses such as data storage devices (sometimes referred to herein as “storage 704”), without limitation. Storage 704 includes machine executable code 706 stored thereon (e.g., stored on a computer-readable memory, without limitation) and processors 702 include logic circuitry 708. Machine executable code 706 include information describing functional elements that may be implemented by (e.g., performed by) logic circuitry 708. Logic circuitry 708 is implements (e.g., performs) the functional elements described by machine executable code 706. Device 700, when executing the functional elements described by machine executable code 706, should be considered as special purpose hardware to carry out the functional elements disclosed herein. In one or more examples, processors 702 may perform the functional elements described by machine executable code 706 sequentially, concurrently (e.g., on one or more different hardware platforms), or in one or more parallel process streams.

When implemented by logic circuitry 708 of processors 702, machine executable code 706 may adapt processors 702 to perform operations of examples disclosed herein. For example, machine executable code 706 may adapt processors 702 to perform at least a portion or a totality of method 400 of FIG. 4, method 500 of FIG. 5A and FIG. 5B, and method 600 of FIG. 6A and FIG. 6B. As another example, machine executable code 706 may adapt processors 702 to perform at least a portion or a totality of the operations discussed for apparatus 100 of FIG. 1, video-data encoder 102 of FIG. 1, apparatus 200 of FIG. 2, video-data encoder 202 of FIG. 2, apparatus 300 of FIG. 3, or video-data encoder 302 of FIG. 3.

Processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes computing instructions (e.g., software code, without limitation) related to examples. It is noted that a general-purpose processor (may also be referred to herein as a host processor or simply a host) may be a microprocessor, but in the alternative, processors 702 may include any conventional processor, controller, microcontroller, or state machine. Processors 702 may also be implemented as a combination of computing devices, such as a combination of a DSP and a microprocessor, a plurality of microprocessors, one or more microprocessors in conjunction with a DSP core, or any other such configuration.

In one or more examples, storage 704 includes volatile data storage (e.g., random-access memory (RAM), without limitation), non-volatile data storage (e.g., Flash memory, a hard disc drive, a solid state drive, erasable programmable read-only memory (EPROM), without limitation). In one or more examples, processors 702 and storage 704 may be implemented into a single device (e.g., a semiconductor device product, a system on chip (SOC), without limitation). In one or more examples, processors 702 and storage 704 may be implemented into separate devices.

In one or more examples, machine executable code 706 may include computer-readable instructions (e.g., software code, firmware code, without limitation). By way of non-limiting example, the computer-readable instructions may be stored by storage 704, accessed directly by processors 702, and executed by processors 702 using at least logic circuitry 708. Also by way of non-limiting example, the computer-readable instructions may be stored on storage 704, transmitted to a memory device (not shown) for execution, and executed by processors 702 using at least logic circuitry 708. Accordingly, in one or more examples, logic circuitry 708 includes electrically configurable logic circuitry.

In one or more examples, machine executable code 706 may describe hardware (e.g., circuitry, without limitation) to be implemented in logic circuitry 708 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in one or more examples, machine executable code 706 may include an HDL, an RTL, a GL description, a mask level description, other hardware description, or any combination thereof.

In examples where machine executable code 706 includes a hardware description (at any level of abstraction), a system (not shown, but including storage 704) may implement the hardware description described by machine executable code 706. By way of non-limiting example, processors 702 may include a programmable logic device (e.g., an FPGA or a PLC, without limitation) and the logic circuitry 708 may be electrically controlled to implement circuitry corresponding to the hardware description into logic circuitry 708. Also by way of non-limiting example, logic circuitry 708 may include hard-wired logic manufactured by a manufacturing system (not shown, but including storage 704) according to the hardware description of machine executable code 706.

Regardless of whether machine executable code 706 includes computer-readable instructions or a hardware description, logic circuitry 708 performs the functional elements described by machine executable code 706 when implementing the functional elements of machine executable code 706. It is noted that although a hardware description may not directly describe functional elements, a hardware description indirectly describes functional elements that the hardware elements described by the hardware description are capable of performing.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used in the present disclosure, the terms “module” or “component” may refer to specific hardware implementations may perform the actions of the module or component or software objects or software routines that may be stored on or executed by general purpose hardware (e.g., computer-readable media, processing devices, without limitation) of the computing system. In one or more examples, the different components, modules, engines, and services described in the present disclosure may be implemented as objects or processes that execute on the computing system (e.g., as separate threads, without limitation). While some of the system and methods described in the present disclosure are generally described as being implemented in software (stored on or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, “each” means “some or a totality.” As used herein, “each and every” means “a totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” or “an” means “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, without limitation” or “one or more of A, B, and C, without limitation.” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure may include:

Example 1: An apparatus comprising: a video-data encoder to: encode a 4×4 data block into a bit stream according to a context adaptive variable length coding, the 4×4 data block representative of video data; and while encoding the 4×4 data block, ignore at least some coefficients of the 4×4 data block.

Example 2: The apparatus of Example 1, wherein the video-data encoder to ignore the at least some coefficients of the 4×4 data block by setting the at least some coefficients of the 4×4 data block to zero prior to encoding the 4×4 data block.

Example 3: The apparatus of Examples 1 and 2, wherein after setting the at least some coefficients of the 4×4 data block to zero, the video-data encoder, so as to encode the 4×4 data block into the bit stream, to: count a number of non-zero coefficients of the 4×4 data block; count a number of trailing ones of the 4×4 data block; encode the number of non-zero coefficients and the number of trailing ones according to the context adaptive variable length coding; encode a sign of each of the trailing ones according to the context adaptive variable length coding; encode levels of coefficients according to the context adaptive variable length coding; encode a count of zeroes before a last non-zero coefficient according to the context adaptive variable length coding; and encode zeroes before the last non-zero coefficient according to the context adaptive variable length coding.

Example 4: The apparatus of Examples 1 to 3, wherein the video-data encoder to, so as to ignore at least some coefficients of the 4×4 data block while encoding the 4×4 data block, one or more of: not count the at least some coefficients as non-zero coefficients when counting non-zero coefficients according to the context adaptive variable length coding; not count the at least some coefficients as trailing ones when counting trailing ones according to the context adaptive variable length coding; not encode a sign of the at least some coefficients when encoding signs of trailing ones according to the context adaptive variable length coding; not encode a level of the at least some coefficients when encoding levels according to the context adaptive variable length coding; and not include the at least some coefficients when identifying a last non-zero coefficient according to the context adaptive variable length coding.

Example 5: The apparatus of Examples 1 to 4, wherein the at least some coefficients comprise at least two coefficients.

Example 6: The apparatus of Examples 1 to 5, wherein the at least some coefficients comprise a last two coefficients of the 4×4 data block, according to a zig-zag scan pattern of the coefficients in the 4×4 data block.

Example 7: The apparatus of Examples 1 to 6, wherein the video-data encoder to encode the number of non-zero coefficients and the number of trailing ones and to encode the sign of each of the trailing ones during the same clock cycle.

Example 8: The apparatus of Examples 1 to 7, wherein the video-data encoder to encode the 4×4 data block into the bit stream in 16, or fewer, clock cycles.

Example 9: An apparatus comprising: a video-data encoder to: encode a 4×4 data block into a bit stream according to a context adaptive variable length coding, the 4×4 data block representative of the video data; and while encoding the 4×4 data block, ignore at least some coefficients of the 4×4 data block, to thereby encode video data to generate compressed video data.

Example 10: The apparatus of Example 9, wherein the video-data encoder to set at least some coefficients of the 4×4 data block to zero prior to encoding the 4×4 data block so as to ignore the at least some coefficients of the 4×4 data block.

Example 11: The apparatus of Examples 9 and 10, wherein the video-data encoder, after setting the at least some coefficients of the 4×4 data block to zero, to: count a number of non-zero coefficients of the 4×4 data block according to the context adaptive variable length coding; count a number of trailing ones of the 4×4 data block according to the context adaptive variable length coding; encode the number of non-zero coefficients and the number of trailing ones according to the context adaptive variable length coding; encode a sign of each of the trailing ones according to the context adaptive variable length coding; encode levels of coefficients according to the context adaptive variable length coding; encode a count of zeroes before a last non-zero coefficient according to the context adaptive variable length coding; and encode zeroes before the last non-zero coefficient according to the context adaptive variable length coding, to thereby encode the 4×4 data block into the bit stream.

Example 12: The apparatus of Examples 9 to 11, wherein the video-data encoder to, one or more of: not count the at least some coefficients as non-zero coefficients when counting non-zero coefficients according to the context adaptive variable length coding; not count the at least some coefficients as trailing ones when counting trailing ones according to the context adaptive variable length coding; not encode a sign of the at least some coefficients when encoding signs of trailing ones according to the context adaptive variable length coding; not encode a level of the at least some coefficients when encoding levels according to the context adaptive variable length coding; and not include the at least some coefficients when identifying a last non-zero coefficient according to the context adaptive variable length coding, to thereby ignore at least some coefficients of the 4×4 data block while encoding the 4×4 data block.

Example 13: The apparatus of Examples 9 to 12, wherein the at least some coefficients comprise at least two coefficients.

Example 14: The apparatus of Examples 9 to 13, wherein the at least two coefficients comprise a last two coefficients of the 4×4 data block, according to a zig-zag scan pattern of the coefficients in the 4×4 data block, to zero.

Example 15: The apparatus of Examples 9 to 14, wherein the video-data encoder to: transform a data block representative of a group of pixels of an image of the video data, using an integer transform; and quantize the transformed data block to generate the 4×4 data block.

Example 16: A method comprising: encoding video data to generate compressed video data, the encoding comprising: encoding a 4×4 data block into a bit stream according to a context adaptive variable length coding, the 4×4 data block representative of the video data; and while encoding the 4×4 data block, ignoring at least some coefficients of the 4×4 data block.

Example 17: The method of Example 16, wherein ignoring the at least some coefficients of the 4×4 data block comprises setting at least some coefficients of the 4×4 data block to zero prior to encoding the 4×4 data block.

Example 18: The method of Examples 16 and 17, wherein encoding the 4×4 data block into the bit stream comprises, after setting the at least some coefficients of the 4×4 data block to zero: counting a number of non-zero coefficients of the 4×4 data block according to the context adaptive variable length coding; counting a number of trailing ones of the 4×4 data block according to the context adaptive variable length coding; encoding the number of non-zero coefficients and the number of trailing ones according to the context adaptive variable length coding; encoding the sign of each of the trailing ones according to the context adaptive variable length coding; encoding levels of coefficients according to the context adaptive variable length coding; encoding a count of zeroes before a last non-zero coefficient according to the context adaptive variable length coding; and encoding zeroes before the last non-zero coefficient according to the context adaptive variable length coding.

Example 19: The method of Examples 16 to 18, wherein encoding the 4×4 data block into the bit stream while ignoring the at least some coefficients of the 4×4 data block comprises one or more of: not counting the at least some coefficients as non-zero coefficients when counting non-zero coefficients according to the context adaptive variable length coding; not counting the at least some coefficients as trailing ones when counting trailing ones according to the context adaptive variable length coding; not encoding a sign of the at least some coefficients when encoding signs of trailing ones according to the context adaptive variable length coding; not encoding a level of the at least some coefficients when encoding levels according to the context adaptive variable length coding; and not including the at least some coefficients when identifying a last non-zero coefficient according to the context adaptive variable length coding.

Example 20: The method of Examples 16 to 19, further comprising: transforming a data block representative of a group of pixels of an image of the video data, using an integer transform; and quantizing the transformed data block to generate the 4×4 data block.

While the present disclosure has been with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a video-data encoder to:
encode a 4×4 data block into a bit stream according to a context adaptive variable length coding, the 4×4 data block representative of video data; and
while encoding the 4×4 data block, ignore at least some coefficients of the 4×4 data block.

2. The apparatus of claim 1, wherein the video-data encoder to ignore the at least some coefficients of the 4×4 data block by setting the at least some coefficients of the 4×4 data block to zero prior to encoding the 4×4 data block.

3. The apparatus of claim 2, wherein after setting the at least some coefficients of the 4×4 data block to zero, the video-data encoder, so as to encode the 4×4 data block into the bit stream, to:
count a number of non-zero coefficients of the 4×4 data block;
count a number of trailing ones of the 4×4 data block;
encode the number of non-zero coefficients and the number of trailing ones according to the context adaptive variable length coding;
encode a sign of each of the trailing ones according to the context adaptive variable length coding;
encode levels of coefficients according to the context adaptive variable length coding;
encode a count of zeroes before a last non-zero coefficient according to the context adaptive variable length coding; and
encode zeroes before the last non-zero coefficient according to the context adaptive variable length coding.

4. The apparatus of claim 1, wherein the video-data encoder to, so as to ignore at least some coefficients of the 4×4 data block while encoding the 4×4 data block, one or more of:
not count the at least some coefficients as non-zero coefficients when counting non-zero coefficients according to the context adaptive variable length coding;
not count the at least some coefficients as trailing ones when counting trailing ones according to the context adaptive variable length coding;
not encode a sign of the at least some coefficients when encoding signs of trailing ones according to the context adaptive variable length coding;
not encode a level of the at least some coefficients when encoding levels according to the context adaptive variable length coding; and
not include the at least some coefficients when identifying a last non-zero coefficient according to the context adaptive variable length coding.

5. The apparatus of claim 1, wherein the at least some coefficients comprise at least two coefficients.

6. The apparatus of claim 1, wherein the at least some coefficients comprise a last two coefficients of the 4×4 data block, according to a zig-zag scan pattern of the coefficients in the 4×4 data block.

7. The apparatus of claim 1, wherein the video-data encoder to encode the number of non-zero coefficients and the number of trailing ones and to encode the sign of each of the trailing ones during the same clock cycle.

8. The apparatus of claim 1, wherein the video-data encoder to encode the 4×4 data block into the bit stream in 16, or fewer, clock cycles.

9. An apparatus comprising:
a video-data encoder to:
encode a 4×4 data block into a bit stream according to a context adaptive variable length coding, the 4×4 data block representative of the video data; and
while encoding the 4×4 data block, ignore at least some coefficients of the 4×4 data block, to thereby encode video data to generate compressed video data.

10. The apparatus of claim 9, wherein the video-data encoder to set at least some coefficients of the 4×4 data block to zero prior to encoding the 4×4 data block so as to ignore the at least some coefficients of the 4×4 data block.

11. The apparatus of claim 10, wherein the video-data encoder, after setting the at least some coefficients of the 4×4 data block to zero, to:
count a number of non-zero coefficients of the 4×4 data block according to the context adaptive variable length coding;
count a number of trailing ones of the 4×4 data block according to the context adaptive variable length coding;
encode the number of non-zero coefficients and the number of trailing ones according to the context adaptive variable length coding;
encode a sign of each of the trailing ones according to the context adaptive variable length coding;
encode levels of coefficients according to the context adaptive variable length coding;
encode a count of zeroes before a last non-zero coefficient according to the context adaptive variable length coding; and
encode zeroes before the last non-zero coefficient according to the context adaptive variable length coding,
to thereby encode the 4×4 data block into the bit stream.

12. The apparatus of claim 9, wherein the video-data encoder to, one or more of:
not count the at least some coefficients as non-zero coefficients when counting non-zero coefficients according to the context adaptive variable length coding;
not count the at least some coefficients as trailing ones when counting trailing ones according to the context adaptive variable length coding;
not encode a sign of the at least some coefficients when encoding signs of trailing ones according to the context adaptive variable length coding;
not encode a level of the at least some coefficients when encoding levels according to the context adaptive variable length coding; and
not include the at least some coefficients when identifying a last non-zero coefficient according to the context adaptive variable length coding,
to thereby ignore at least some coefficients of the 4×4 data block while encoding the 4×4 data block.

13. The apparatus of claim 9, wherein the at least some coefficients comprise at least two coefficients.

14. The apparatus of claim 13, wherein the at least two coefficients comprise a last two coefficients of the 4×4 data block, according to a zig-zag scan pattern of the coefficients in the 4×4 data block, to zero.

15. The apparatus of claim 9, wherein the video-data encoder to:
transform a data block representative of a group of pixels of an image of the video data, using an integer transform; and
quantize the transformed data block to generate the 4×4 data block.

16. A method comprising:
encoding video data to generate compressed video data, the encoding comprising:
encoding a 4×4 data block into a bit stream according to a context adaptive variable length coding, the 4×4 data block representative of the video data; and
while encoding the 4×4 data block, ignoring at least some coefficients of the 4×4 data block.

17. The method of claim 16, wherein ignoring the at least some coefficients of the 4×4 data block comprises setting at least some coefficients of the 4×4 data block to zero prior to encoding the 4×4 data block.

18. The method of claim 17, wherein encoding the 4×4 data block into the bit stream comprises, after setting the at least some coefficients of the 4×4 data block to zero:
counting a number of non-zero coefficients of the 4×4 data block according to the context adaptive variable length coding;
counting a number of trailing ones of the 4×4 data block according to the context adaptive variable length coding;
encoding the number of non-zero coefficients and the number of trailing ones according to the context adaptive variable length coding;
encoding the sign of each of the trailing ones according to the context adaptive variable length coding;
encoding levels of coefficients according to the context adaptive variable length coding;
encoding a count of zeroes before a last non-zero coefficient according to the context adaptive variable length coding; and
encoding zeroes before the last non-zero coefficient according to the context adaptive variable length coding.

19. The method of claim 16, wherein encoding the 4×4 data block into the bit stream while ignoring the at least some coefficients of the 4×4 data block comprises one or more of:
not counting the at least some coefficients as non-zero coefficients when counting non-zero coefficients according to the context adaptive variable length coding;
not counting the at least some coefficients as trailing ones when counting trailing ones according to the context adaptive variable length coding;
not encoding a sign of the at least some coefficients when encoding signs of trailing ones according to the context adaptive variable length coding;
not encoding a level of the at least some coefficients when encoding levels according to the context adaptive variable length coding; and
not including the at least some coefficients when identifying a last non-zero coefficient according to the context adaptive variable length coding.

20. The method of claim 16, further comprising:
transforming a data block representative of a group of pixels of an image of the video data, using an integer transform; and
quantizing the transformed data block to generate the 4×4 data block.
